(19) United States
(12) Patent Application Publication
(10) Pub. No.: US 2005/0084040 A1
(43) Pub. Date: Apr. 21, 2005

(54) Method for modulation detection

(76) Inventors: Kenneth A. Stewart, Grayslake, IL (US); Raja S. Bachu, Waukegan, IL (US); Michael E. Buckley, Grayslake, IL (US); Clint S. Wilkins, Chicago, IL (US)

Correspondence Address: MOTOROLA INC, 600 NORTH US HIGHWAY 45, ROOM AS437, LIBERTYVILLE, IL, 60048-5343, US

(21) Appl. No.: 10/689,201

(22) Filed: Oct. 20, 2003

(51) Int. Cl. H04L 27/14

(52) U.S. Cl. 375/324

(57) ABSTRACT

A method of modulation detection. A signal is received. A first decision statistic can be generated based on the received signal. The received signal can be transformed. A second decision statistic can be generated based on the transformed received signal. A selected modulation type can be determined based on comparing the first decision statistic with the second decision statistic.

### BACKGROUND

1. Field

This invention relates generally to communication systems, and more particularly to reducing the likelihood that the modulation method used to transmit a signal is misidentified by the receiver due to the presence of interference.

2. Description of Related Art

Presently, wireless communication systems, such as the Global System for Mobile Communications (GSM), have been designed to meet the increasing need for ubiquitous personal communications capable of supporting both voice and data services. Cellular systems such as GSM are designed to exploit the concept of frequency re-use; that is, where a specific radio frequency (RF) carrier is used in multiple cells within a given geographic region. Base stations (BS) and mobile stations (MS) within this geographic region are required to accept co-channel and adjacent channel interference from other base stations or mobile stations in the area. The level of interference is controlled by an appropriately constructed frequency re-use pattern or by the use of frequency-hopping methods for interference averaging.

Naturally, receivers operating in such environments are primarily concerned with the accurate demodulation of voice or data channel transmissions. Nevertheless, base stations and mobile stations designed to receive transmissions associated with the Enhanced Data for GSM Evolution (EDGE) enhanced General Packet Radio Service (GPRS) packet data transmission mode of GSM (sometimes referred to as “EGPRS”) must, however, receive transmissions using both Gaussian Minimum Shift Keying (GMSK) and 8-ary Phase Shift Keying (8-PSK) modulation. Since the modulation type associated with any particular EGPRS transmission is not explicitly signaled by the transmitter, the receiver must autonomously determine the modulation type used for the transmission as well as performing demodulation of the data signal. This function, usually referred to as format detection or more frequently referred to as modulation detection, must have performance consistent with the associated demodulation performance. That is, the probability of the receiver misdetecting the modulation type, e.g. identifying an EGPRS GMSK transmission as an 8-PSK transmission, should ideally be sufficiently low that the overall probability of receiving a transmitted data symbol in error is not significantly increased over the case where the modulation type is known to the receiver without error.

Recently, the 3^{rd} Generation Partnership Project (3GPP) standards working group responsible for the GSM and EDGE Radio Access Network (GERAN) specification has been studying the feasibility of improved receiver performance under interference-limited conditions. Receivers compliant to such an improved performance specification would be required to maintain a specified demodulation performance—defined, for example, in terms of a reference bit error rate (BER), frame error rate (FER), or block error rate (BLER)—at a lower desired carrier to interfering signal power ratio or equivalently C/I ratio than conventional receivers. Typically, this is achieved by implementing interference-canceling receiver architectures which are designed to mitigate the effects of particular interfering waveforms, e.g. transmissions to other GSM and EDGE mobile or base stations, on the desired signal demodulation process.

Any requirement for improved demodulation performance in EGPRS links (enabled by interference canceling receivers) also implies however, that modulation detection performance must also be improved if that aspect of receiver operation is not to become the performance-limiting component. That is, there is a need for an improved method of modulation detection for EGPRS transmissions (or more generally, for any transmission requiring modulation detection) when the associated receiver demodulation function is capable of enhanced performance in interference-limited conditions. It would also be advantageous if the method for achieving this was a low-complexity solution, capable of being implemented on a programmable device without necessarily requiring new hardware resources.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 is an exemplary illustration of a format of a GSM burst, such as a normal burst, according to one embodiment;

FIG. 2 is an illustration of an exemplary set of training sequence codes selectable in a GSM network according to one embodiment;

FIG. 3 is an exemplary illustration of a Gray-encoded 8-PSK constellation according to one embodiment;

FIG. 4 is an exemplary flowchart of a modulation detection method according to one embodiment;

FIG. 5 is an exemplary flowchart of a modulation detection procedure in accordance with another embodiment;

FIG. 6 is an exemplary graph showing modulation detection performance according to one embodiment;

FIG. 7 is an exemplary flowchart of a modulation detection procedure in accordance with another embodiment;

FIG. 8 is an exemplary block diagram of a system according to one embodiment; and

FIG. 9 is an exemplary block diagram of a communication device according to one embodiment.

### DETAILED DESCRIPTION

Although the disclosure is described in terms of one embodiment of EGPRS modulation detection, it will be appreciated that the invention is broadly applicable to situations where the modulation type of the transmission is not already known or explicitly signaled to the receiver.

According to one embodiment, the disclosure provides a method for improving modulation detection in a GSM communication system. The method uses an embedded interference-canceling algorithm in constructing the decision statistic to drive the hypothesis test underlying the modulation detection decision. The method can include a first step of establishing an error metric based on an estimate of the training sequence generated by a quasi-linear filter, conditioned on the hypothesized modulation type, and then a second step of comparing the decision statistic associated with each modulation type in order to determine the modulation. As a third step, the error metrics generated by the first step under each hypothesis may be accumulated to generate error metrics by which the modulation type associated with each Radio Link Control (RLC) block may be identified.

According to a related embodiment, the disclosure provides a method of modulation detection. The method can include receiving a signal, generating a first decision statistic based on the received signal, phase rotating the received signal, generating a second decision statistic based on the phase rotated received signal, and determining a selected modulation type based on comparing the first decision statistic with the second decision statistic. The method can also include generating an observation matrix from the received signal, wherein the first decision statistic is generated based on the observation matrix. The method can additionally include generating an observation matrix from the phase-rotated received signal, wherein the second decision statistic is generated based on the observation matrix. The step of determining a selected modulation type can include comparing the first decision statistic with the second decision statistic, determining a desired modulation to be a first modulation type if the first decision statistic is less than or equal to the second decision statistic, and determining a desired modulation to be a second modulation type if the second decision statistic is less than the first decision statistic. The step of determining a selected modulation type can determine the selected modulation type to be a Gaussian minimum shift keying modulation type, an octal phase shift keying modulation type, or any other useful modulation type, based on comparing the first decision statistic with the second decision statistic. Generating a first decision statistic can include generating the first decision statistic based on four bursts comprising a radio link control bock of the received signal. The first decision statistic can be generated according to ε₀=b^{T}(I−Z₀(Z₀^{T}Z₀)⁻¹Z₀)b. The second decision statistic can be generated according to ε₁=b^{T}(I−Z₁(Z₁^{T}Z₁)⁻¹Z₁)b.

According to a related embodiment, the disclosure provides a method of modulation detection. The method can include receiving a signal, constructing a first decision statistic based on a first hypothesized modulation type including interference suppression based on the received signal, constructing a second decision statistic based on a second hypothesized modulation type including interference suppression based on the received signal, and identifying a selected modulation type based on a comparison of the first decision statistic and the second decision statistic. The first hypothesized modulation type can be a Gaussian minimum shift keying modulation type. The second hypothesized modulation type can be an octal phase shift keying modulation type. The method can also include transforming the received signal where the second decision statistic can be based on transformed received signal. Transforming the received signal can include phase rotating the received signal or any other useful transformation. The first decision statistic can be generated according to ε₀=b^{T}(I−Z₀(Z₀^{T}Z₀)⁻¹Z₀)b. The second decision statistic can be generated according to ε₁=b^{T}(I−Z₁(Z₁^{T}Z₁)⁻¹Z₁)b. Identifying a selected modulation type can include comparing the first decision statistic with the second decision statistic, determining a desired modulation to be a first modulation type if the first decision statistic is less than or equal to the second decision statistic, and determining a desired modulation to be a second modulation type if the first decision statistic is greater than the second decision statistic. The first modulation type can be a Gaussian minimum shift keying modulation type, an octal phase shift keying modulation type, or any other useful modulation type. Constructing a first decision statistic can include constructing the first decision statistic based on four bursts comprising a radio link control bock of the received signal.

According to a related embodiment, the disclosure provides a method of modulation detection. The method can include receiving a signal, generating a first observation matrix from the received signal, computing first decision statistic from first observation matrix, phase-rotating the received signal, generating a second observation matrix from the phase-rotated received signal, computing a second decision statistic from the second observation matrix, comparing the first decision statistic with the second decision statistic, determining a desired modulation to be a Gaussian minimum shift keying modulation if the first statistic is less than or equal to the second statistic, and determining a desired modulation to be an octal phase shift keying modulation if the second statistic is less than the first statistic.

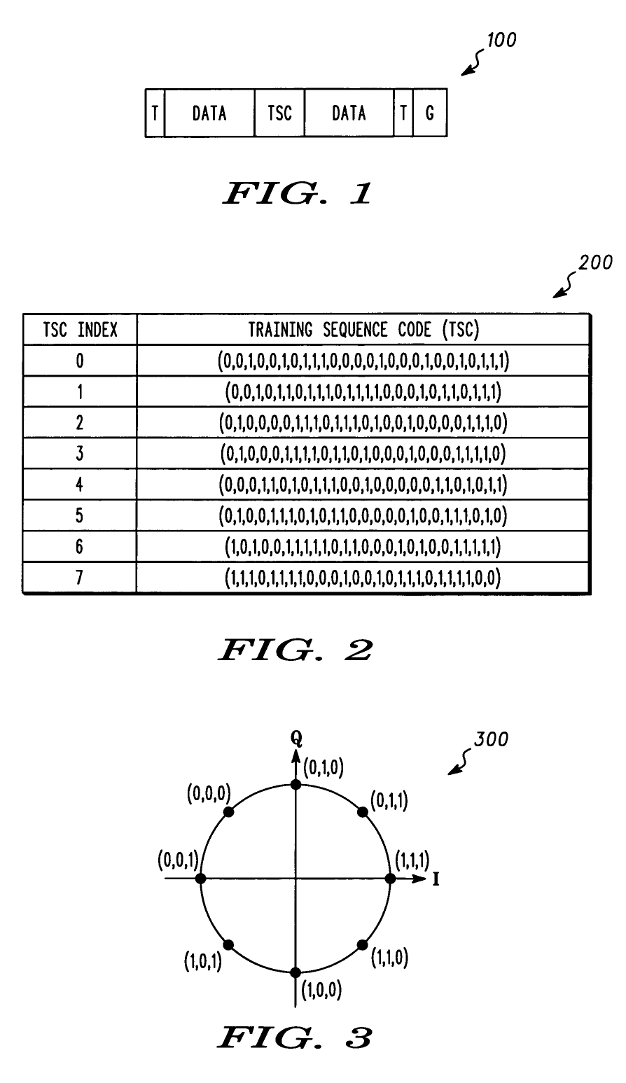

FIG. 1 is an exemplary illustration of a normal burst 100, which is the basic unit of transmission for both circuit- and packet-switched GSM logical channels. Other burst formats are defined in GSM, but can be reserved for signaling, frequency correction or other purposes. The format of the normal burst 100 can comprise two tail bit fields, denoted ‘T’, of length equal to 3 symbols, two encrypted data fields (‘Data’) of length-58 symbols, the midamble or training sequence code (TSC) of length 26 symbols, and the guard interval, denoted ‘G’, of nominal length 8.25 symbols. The symbols comprising the burst can be, for example, either binary or octal (i.e. 8-ary) symbols, depending on whether the Gaussian Minimum Shift Keying (GMSK) or octal phase shift keying (8-PSK) modulation types are used.

FIG. 2 is an exemplary table 200 of a binary-valued symbol sequence comprising each element of the set of available training sequence codes according to one embodiment. For normal bursts, a total of eight selectable TSC fields are defined in GSM networks and known to both the transmitter and receiver before transmission commences. Each individual length-26 TSC comprises a sequence of cyclically-extended binary codewords with a fundamental length of 16 symbols, and which exhibit good cyclic autocorrelation properties. For the present purpose, the binary symbol sequence corresponding to the particular TSC selected from FIG. 2 is denoted b′ₖ.

When GMSK modulation is used to transmit the normal burst, transmission of the midamble is performed, as for the data, tail and guard fields, according to principles of GMSK modulation in the GSM system. That is, the binary symbols comprising the TSC are differentially encoded, and then phase-modulated according to principles of minimum shift keying with a Gaussian pre-filter with a bandwidth-time (BT) product of 0.3.

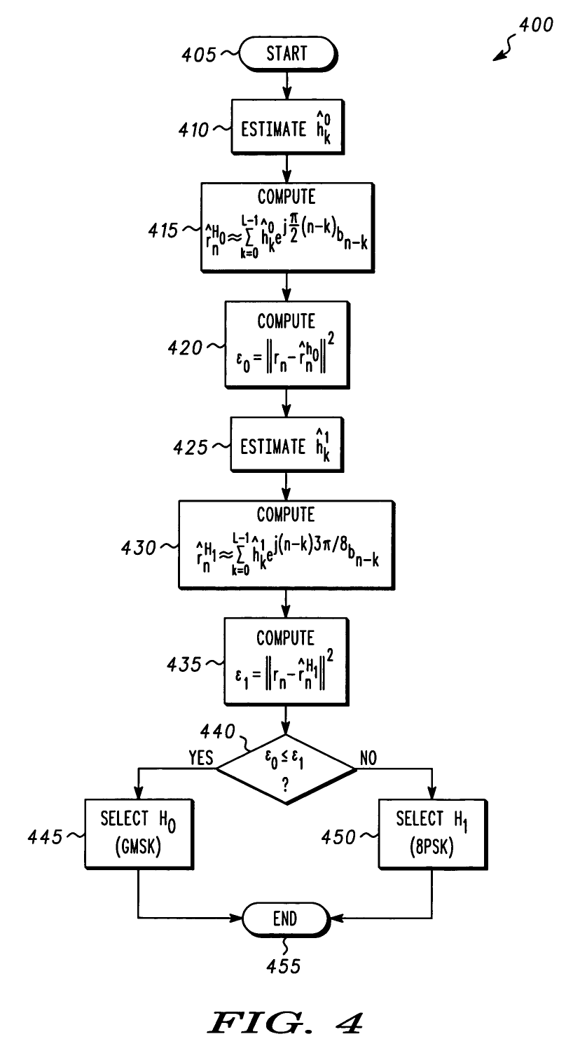

FIG. 3 is an exemplary illustration of real-valued elements of a Gray-encoded 8-PSK constellation 300 according to one embodiment. When 8-PSK modulation is used to transmit the normal burst, each binary symbol of the selected TSC is first mapped onto the real-valued elements of a Gray-encoded 8-PSK constellation. That is, a TSC symbol ‘0’ is mapped to constellation element ‘111’ and a TSC symbol ‘1’ is mapped to constellation element ‘001’. The resulting complex-valued symbols are then subject to a per-symbol phase-shift of 3π/8 radians before linear pulse-shaping, frequency conversion, and transmission.

When discriminating between GMSK and 8-PSK modulated bursts, the primary task of a receiver is to select which of the two alternate representations of the same fundamental training sequence b′ₖ has been received. No other explicit signaling distinction is made between GMSK and 8-PSK formatted bursts.

Consider next the modulation detection problem in the context of an interference canceling (IC) receiver. It is useful here to first briefly describe the fundamentals of a particular IC GSM receiver used in the embodiment described below, although other interference-canceling receiver designs can also be used. In the description below, quantities (.)^{T}, (.)^{H}, (.)⁻¹ represent the transposition, conjugate transposition, and inversion of matrices, respectively, and bold letters indicate vectors or matrices.

In more detail, one method to reject co-channel and adjacent channel interference in a GSM system is to use a quasi-linear finite-impulse-response (FIR) filter trained using the training sequence. This uses the linear approximation to GMSK modulation, which permits an approximately-equivalent transmitted symbol sequence aₖ to be defined as:

$${a}_{k} ∈ \{ \begin{matrix}\{ \pm 1 \} , k ∈ \{ 1 , 3 , 5 , … \} \\ \{ \pm j \} , k ∈ \{ 2 , 4 , 6 , … \}\end{matrix} \qquad ( 1.1 )$$

In other words, when GMSK modulation is used, each transmitted symbol aₖ in the GSM system can be viewed as a binary antipodal constellation occupying alternately the in-phase (I) or quadrature (Q) signal component.

Viewed simply in terms of symbol-rate sampling, by using the training sequence region rₙ,n∈{61,63, ,86} of the received signal rₙ, which corresponds to the received training sequence of the first hypothesized arriving ray of the received signal, a quasi-linear estimator of the transmitted symbol sequence can be constructed by minimizing a modified sum-squared error metric over the TSC defined as:

$$ɛ = {\sum }_{k = 61}^{86} {\vert {\hat{a}}_{k} - {a}_{k} \vert}^{2} \qquad ( 1.2 )$$

where âₖ is restricted to be purely real or purely imaginary, in accordance with aₖ.

Again, in more detail, defining the binary antipodal form of the training sequence as bₖ=1−2b′ₖ, and the quasi-linear estimate of bₖ as \hat{b}ₖ, and defining the length-N observation vector y(k), or equivalently yₖ, input to the quasi-linear estimator as:
yₖ=[rₖ, rₖ₋₁, . . . , r_{k-N+1}]^{T} (1.3)
then the quasi-linear estimate \hat{b}_{k-N+1} of the k−N+1-th training symbol b_{k-N+1} is formed (over the training sequence interval k−N+1∈{61, 62, . . . , 86}) according to:
\hat{b}_{k-N+1}=F_{k-N+1}(w^{H}yₖ) (1.4)
where w is a complex-valued, length-N weight vector, and function F₁(x), which varies according to the estimated symbol index, generates either the real or imaginary part of its argument according to:

$${F}_{l} ( x ) = \{ \begin{matrix}{( - 1 )}^{1 / 2} Re ( x ) , l ∈ \{ 62 , 64 , … , 86 \} \\ {( - 1 )}^{( l - 1 ) / 2} Im ( x ) , l ∈ \{ 61 , 63 , … , 85 \}\end{matrix} \qquad ( 1.5 )$$

By decomposing the weight and observation vectors into their respective real and imaginary components—i.e. simply that w=wᵣ+jwᵢ and y=yᵣ+jyᵢ—and noting Re(w^{H}y)=yᵣ^{T}wᵣ+yᵢ^{T}wᵢ and Im(w^{H}y)=yᵢ^{T}wᵣ−yᵣ^{T}wᵢ, the weight vector w can be computed to minimize the estimation error over the training sequence
ε=∥b−\hat{b}∥² (1.6)
where:

$$\hat{b} = [ \begin{matrix}{y}_{i} ( D + N - 1 ) & - {y}_{r} ( D + N - 1 ) \\ - {y}_{r} ( D + N ) & - {y}_{i} ( D + N ) \\ ⋮ & ⋮ \\ {y}_{i} ( D + N + 23 ) & - {y}_{r} ( D + N + 23 ) \\ - {y}_{r} ( D + N + 24 ) & - {y}_{i} ( D + N + 24 )\end{matrix} ] [ \begin{matrix}{w}_{r} \\ {w}_{i}\end{matrix} ] = Zw \qquad ( 1.7 )$$

and where b is a vector of training sequence elements bₖ, \hat{b} is an estimate of b, D=61 is the index of the first training sequence symbol, and wᵣ and wᵢ are respectively the real and imaginary parts of w.

Equation (1.7) can be solved using, for example, the classical least-squares approach, to generate the optimal solution vector w as:
w=(Z^{T}Z)⁻¹Z^{T}b (1.8)

Notably, the error metric ε over the midamble (defined in equation (1.2), or equivalently in equation (1.6)) can then be computed in terms of the observation matrix Z and the training sequence vector b according to:
ε=b^{T}(I−Z(Z^{T}Z)⁻¹Z)b (1.9)

That is, ε is a measure of the square-error between the training sequence and the estimate of the training sequence that would have resulted had the training sequence estimate \hat{b}ₖ been compared with the actual training sequence bₖ over the training sequence interval. It is thus a useful measure on which to base a hypothesis test to select between modulation types, and it has the additional advantage that since quasi-linear estimation of the type described above is capable of interference suppression, the hypothesis test benefits from the incorporation of interference suppression in the generation of the hypothesis test decision statistic.

In the present context, this approach to interference suppression can also be applied to the problem of modulation detection in EGPRS links by incorporating the error metric of equation (1.6) into a hypothesis test used as the basis of the modulation detection procedure.

FIG. 4 is an exemplary flowchart 400 outlining the operation of constructing a modulation detection decision statistic used to discriminate modulation types according to one embodiment. In step 405, the flowchart 400 begins. Let hypothesis H₀ correspond to the case where a transmitted burst uses GMSK modulation, while hypothesis H₁ corresponds to the 8-PSK modulated case. In step 415, under hypothesis H₀, where the burst is assumed to be GMSK-modulated, the signal corresponding to the training sequence observed at the output of the multipath channel is:

$${r}_{n}^{{H}_{0}} = {\sum }_{k = 0}^{L - 1} {h}_{k} {ⅇ}^{j \frac{π}{2} ( n - k )} {b}_{n - k} \qquad ( 1.10 )$$

where hₖ is the desired signal multipath channel impulse response of length L, and bₖ is the binary TSC symbol sequence.

In step 430, under hypothesis H₁ that the burst uses 8-PSK modulation, the observed signal rₙ corresponding to the training sequence is given by:

$${r}_{n}^{{H}_{1}} \approx {\sum }_{k = 0}^{L - 1} {h}_{k} {ⅇ}^{j ( n - k ) 3 π / 8} {b}_{n - k} \qquad ( 1.11 )$$

One approach to modulation detection constructs the decision statistic for the hypothesis test by first computing the square-error between the observation rₙ and signals rₙ^{H}^{₀} and rₙ^{H}^{₁} generated respectively by combining the knowledge of the training sequence bₖ with the estimates ĥₖ⁰ and ĥₖ¹ of the multipath channel generated under hypotheses H₀ and H₁ in steps 410 and 425 using, for example, correlation, least-squares channel estimation methods, or the like. In step 420, the decision statistic ε₀ under H₀ is defined by:
ε₀−∥rₙ−\hat{r}ₙ^{H}^{₀}∥² (1.12)
where the formulation of \hat{r}ₙ^{H}^{₀} follows that of equation (1.10) with hₖ replaced by channel estimate ĥₖ⁰.

Similarly, in step 435, the decision statistic ε₁ under H₁ is defined by:
ε₁=∥rₙ−\hat{r}ₙ^{H}^{₁}∥² (1.13)
with \hat{r}ₙ^{H}^{₁} following the definition of equation (1.11) with hₖ again replaced by channel estimate ĥₖ¹. In steps 440, 445, and 450, hypothesis H₀ is then selected if ε₀≦ε₁, otherwise hypothesis H₁ is selected. In step 455, the flowchart 400 ends.

According to another embodiment, rather than using this decision statistic, the alternate decision statistic defined in equation (1.6) is used. Before describing the application of this metric to the problem of modulation detection, however, one further observation is useful concerning the structure of the observed 8-PSK signal under hypothesis H₁.

As described above in equation (1.11), under H₁ the 8-PSK modulated received sequence rₙ is given by:

$${r}_{n}^{{H}_{1}} = {\sum }_{k = 0}^{L - 1} {n}_{k} {ⅇ}^{j ( n - k ) 3 π / 8} {b}_{n - k} \qquad ( 1.14 )$$

If a phase rotation using operator e^{jnπ/8} is applied to the observed burst rₙ^{H}^{₁}, then it can be seen that the resulting observation data sequence \check{r}ₙ^{H}^{₁} has the form:

$$\begin{matrix}{\breve{r}}_{n}^{{H}_{1}} = {ⅇ}^{j n π / 8} {r}_{n}^{{H}_{1}} \\ = {ⅇ}^{j n π / 8} {\sum }_{k = 0}^{L - 1} {h}_{k} {ⅇ}^{j ( n - k ) 3 π / 8} {b}_{n - k} \\ = {\sum }_{k = 0}^{L - 1} {h}_{k} {e}^{+ jk 3 π / 8} {ⅇ}^{j \frac{π}{2} ( n - k )} {b}_{n - k} \\ = {\sum }_{k = 0}^{L - 1} {h}_{k}^{′} {ⅇ}^{j \frac{π}{2} ( n - k )} {b}_{n - k}\end{matrix} \qquad ( 1.15 )$$

Comparison of equation (1.15) with equation (1.10) shows that, after rotation using operator e^{jnπ/8}, and within the bounds of the linearised GMSK approximation, \check{r}ₙ^{H}^{₁} and rₙ^{H}^{₀} have an identical form, with the exception that the effective channel impulse response hₖ is modified to be h′ₖ=hₖ e^{+jk3π/8}.

Accordingly, the same processing applicable under hypothesis H₀ to the GMSK observation rₙ^{H}^{₀}, is also applicable under hypothesis H₁ to the phase-rotated 8-PSK observation \check{r}ₙ^{H}^{₁}.

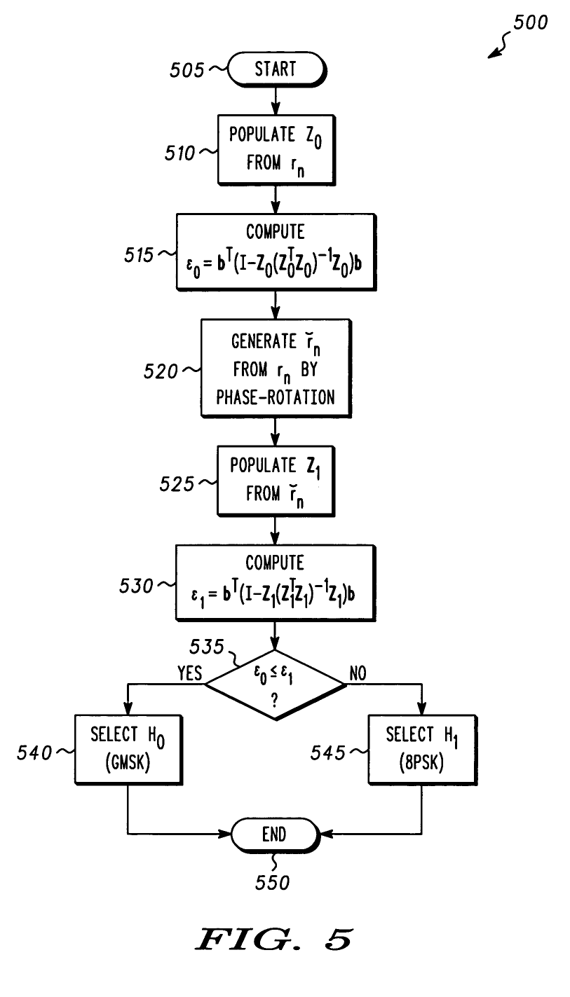

FIG. 5 is an exemplary flowchart 500 outlining a burst modulation detection method according to another embodiment. In step 505, the flowchart begins. In step 510, the observation matrix Z₀ is populated directly from the received signal rₙ in accordance with the definition of Z in equation (1.7), and the definition of vector y in equation (1.3).

In step 515, an error metric, such as a decision statistic, ε₀ is generated under hypothesis H₀ (GMSK modulation), where ε₀ is defined according to equation (1.9):
ε₀=b^{T}(I−Z₀(Z₀^{T}Z₀)⁻¹Z₀)b (1.16)

In step 520, the signal \check{r}ₙ=e^{jnπ/8}rₙ is generated for hypothesis H₁ by phase-rotating the received signal rₙ using operator e^{jnπ/8}.

In step 525, matrix Z₁ is populated from the modified signal r in accordance with the definition of Z in equation (1.7), and the definition of vector y in equation (1.3) where rₖ in equation (1.3) is replaced with \check{r}ₖ.

In step 530, the error metric ε₁ is computed under hypothesis H₁ (8-PSK modulation) according to:
ε₁=b^{T}(I−Z₁(Z₁^{T}Z₁)⁻¹Z₁)b (1.17)

In step 535, the error metric ε₀ for hypothesis H₁ is compared to the error metric ε₁ for hypothesis H₁. In step 540, the hypothesis H₀ (i.e. declare GMSK burst modulation) is selected if ε₀≦ε₁, otherwise, in step 545, hypothesis H₁ is selected (i.e. declare 8-PSK burst modulation). In step 550, the flowchart ends.

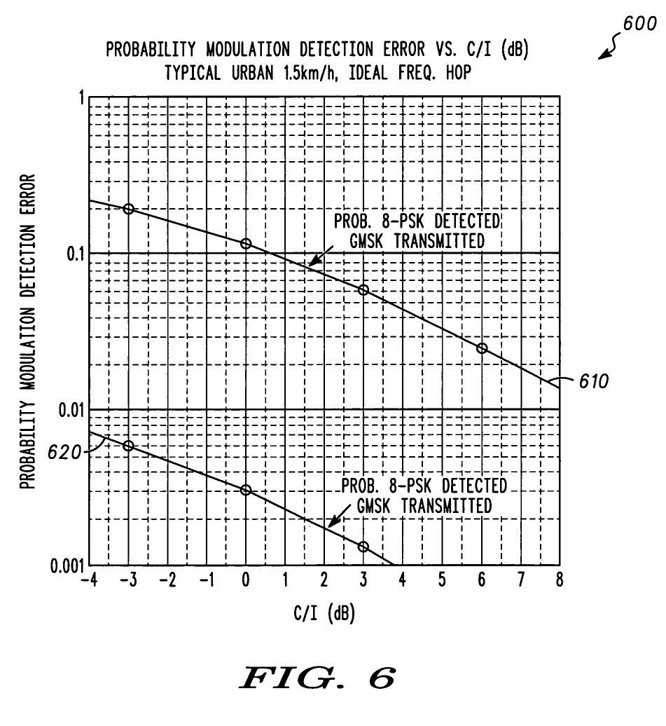

The performance of the method of modulation detection described herein can be understood by reference to FIG. 6, which shows RLC block detection performance 600 for a Typical Urban multipath channel at 1.5 km/h mobile station velocity. It can be seen that while using an existing method 610, the probability of identifying an RLC block transmitted using GMSK as an 8PSK-modulated block is 1% at a carrier to co-channel interference ratio (C/I) of approximately 9 dB, whereas another disclosed modulation detection method 620 achieves the same performance at an improved C/I ratio of approximately −5 dB.

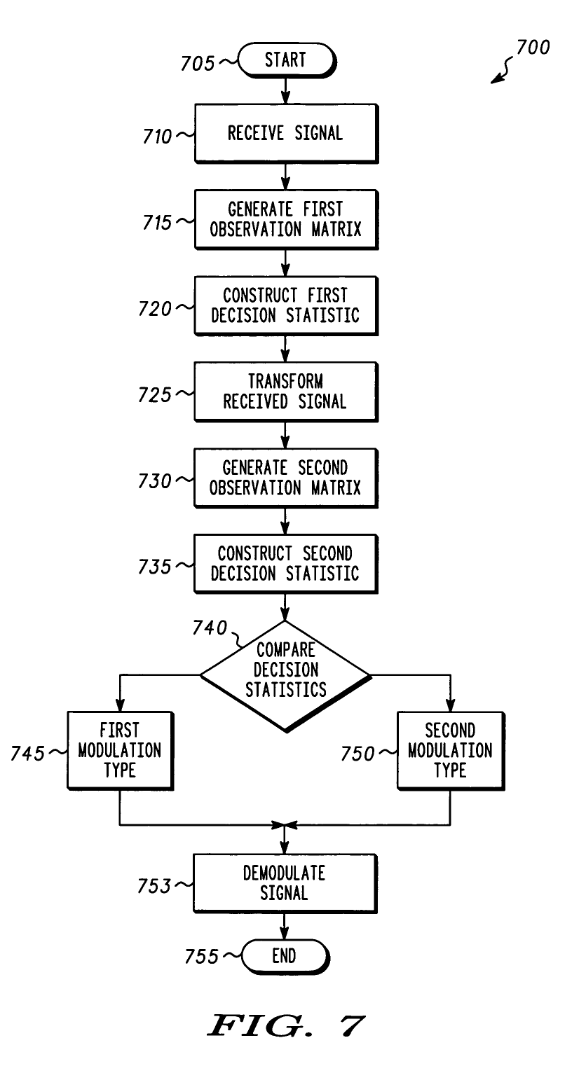

FIG. 7 is an exemplary flowchart 700 outlining the operation of the disclosed method according to another embodiment. In step 705, the flowchart begins. In step 710, a signal is received. According to an alternate embodiment, the signal may include EGPRS Radio Link Control (RLC) data blocks distributed over four normal bursts. For example, noting that EGPRS RLC data blocks are distributed over four normal bursts, and further noting that the same modulation type is applied to each burst comprising an RLC block, a step 710 can include RLC block modulation identification. Thus, under the extended hypothesis H₀^{RLC} that an RLC block is transmitted using GMSK modulation, accumulate ε₀ over the 4 bursts comprising the RLC block to generate block error metric ε₀^{RLC}. Similarly, under the extended hypothesis H₁^{RLC} that an RLC block is transmitted using 8-PSK modulation, accumulate ε₁ over the 4 bursts comprising the RLC block to generate block error metric ε₁^{RLC}. Select H₀^{RLC} (GMSK modulation) if ε₀^{RLC}≦ε₁^{RLC}, else select H₁^{RLC} (8-PSK modulation). In step 715, a first observation matrix is generated based on the received signal. In step 720, a first decision statistic is constructed based on the first observation matrix. In step 725, the received signal is transformed. For example, the received signal may be phase rotated or otherwise transformed. In step 730, a second observation matrix is generated based on the transformed received signal. In step 735, a second decision statistic is constructed based on the second observation matrix. In step 740, the first decision statistic and the second decision statistic are compared. A first modulation type is selected in step 745 or a second modulation type is selected in step 750 based on the comparison. In step 753, the signal can be demodulated according to the selected modulation type. In step 755, the flowchart 700 ends.

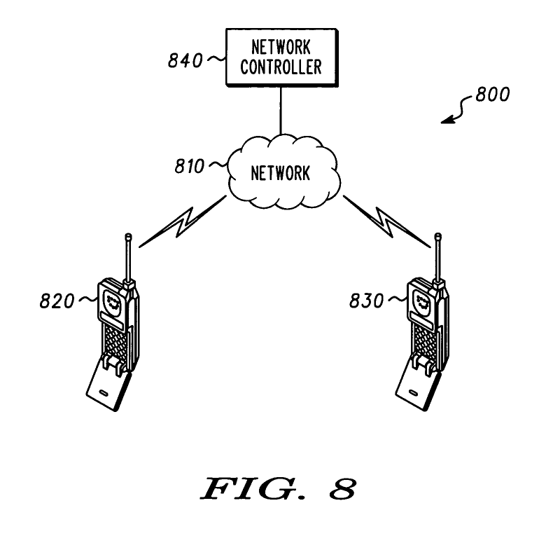

FIG. 8 is an exemplary block diagram of a system 800 according to one embodiment. The system 800 includes a network controller 840, a network 810, and one or more terminals 820 and 830. Terminals 820 and 830 may include telephones, wireless telephones, cellular telephones, PDAs, pagers, personal computers, or any other device that is capable of sending and receiving messaging service messages on a network including wireless network.

In an exemplary embodiment, the network controller 840 is connected to the network 810. For example, the network controller 840 may be located at a base station, or elsewhere on the network. The network 810 may include any type of wireless network that is capable of sending and receiving wireless messaging service messages. For example, the network 810 may include a wireless telecommunications network, a cellular telephone network, a satellite communications network, and other like communications systems capable of sending and receiving wireless messaging service messages. Furthermore, the network 810 may include more than one network and may include a plurality of different types of networks. Thus, the network 810 may include a plurality of data networks, a plurality of telecommunications networks, a combination of data and telecommunications networks and other like communication systems capable of sending and receiving wireless messaging service messages.

In operation, terminals 820 and 830 can be used to send and receive signals and the network controller 840 can control operations on the network. For example, a terminal 820, the network controller 840, or other device in the system 800 can perform the operations disclosed in the flowcharts for detecting a modulation type of a received signal. Each step in the flowcharts may be implemented in a device in the system 800 as software or hardware modules. For example, each step in the flowchart 700 of FIG. 7 may be implemented in independent respective hardware modules in a device. Thus, the flowchart 700 can symbolize the interconnection of the modules in a device. A device can then output or utilize the selected modulation type for demodulating signals of the selected modulation type.

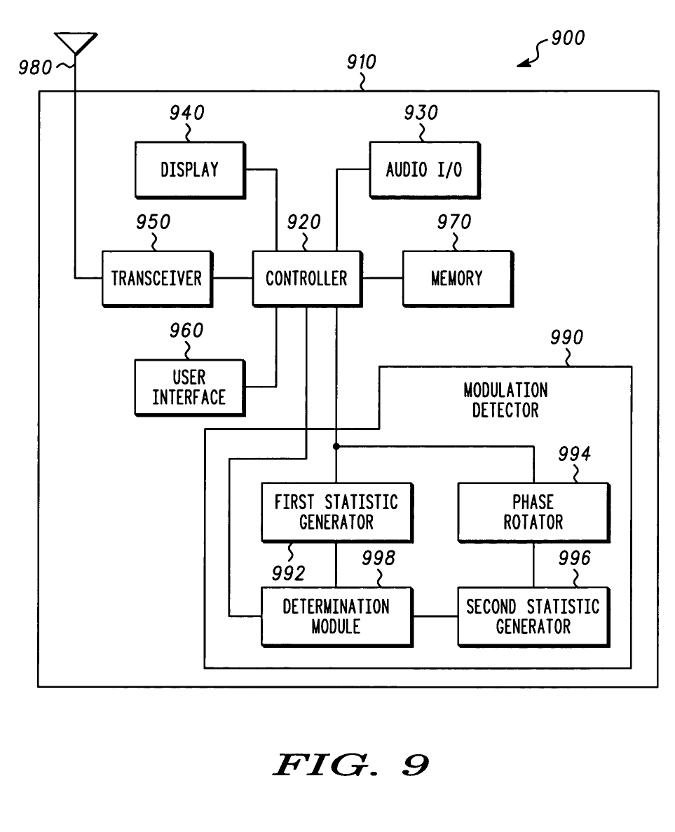

FIG. 9 is an exemplary block diagram of a communication device 900, such as the terminal 820 or the terminal 830, according to one embodiment. The communication device 900 can include a housing 910, a controller 920 coupled to the housing 910, audio input and output circuitry 930 coupled to the housing 910, a display 940 coupled to the housing 910, a transceiver 950 coupled to the housing 910, a user interface 960 coupled to the housing 910, a memory 970 coupled to the housing 910, an antenna 980 coupled to the housing 910 and the transceiver 950, and a modulation detector 990. The display 940 can be a liquid crystal display (LCD), a light emitting diode (LED) display, a plasma display, or any other means for displaying information. The transceiver 950 may include a transmitter and/or a receiver. The audio input and output circuitry 930 can include a microphone, a speaker, a transducer, or any other audio input and output circuitry. The user interface 960 can include a keypad, buttons, a touch pad, a joystick, an additional display, or any other device useful for providing an interface between a user and a electronic device. The memory 970 may include a random access memory, a read only memory, an optical memory, a subscriber identity module memory, or any other memory that can be coupled to a communication device. The modulation detector 990 can include a first decision statistic generator 992, a phase rotator 994, a second decision statistic generator 996, and a determination module 998. The modulation detector 990 and the modules of the modulation detector 990 may reside on the controller 920, in the memory 970, as independent hardware or software modules, or anywhere else on the communication device 900.

In operation, the input and output circuitry 220 can accept various forms of input and output signals. For example, the input and output circuitry 220 can receive and output audio signals and data signals. The memory 230 can store data and software used in the mobile communication device 200. The transceiver 240 can transmit and/or receive data over a wireless network such as network 120. The controller 210 can control the operation of the mobile communication device 200.

The modulation detector 990 can detect a modulation type of the received signal. For example, the a first decision statistic generator 992 can generate a first decision statistic based on a signal received by the transceiver 950, the phase rotator 994 can phase rotate the received signal, the second decision statistic generator 996 can generate a second decision statistic based on the phase rotated received signal, and the determination module 998 can determine a selected modulation type based on comparing the first decision statistic with the second decision statistic. The determination module 998 can return the result to the controller 920 for appropriate processing and adjustment of the communication device 900 for reception of the selected modulation type.

The first decision statistic generator 992 can generate an observation matrix from the received signal, where the first decision statistic is generated based on the observation matrix. The second decision statistic generator 996 can generate an observation matrix from the phase-rotated received signal, where the second decision statistic is generated based on the observation matrix. The determination module 998 can determine a selected modulation type by comparing the first decision statistic with the second decision statistic, determining a desired modulation to be a first modulation type if the first decision statistic is less than or equal to the second decision statistic, and determining a desired modulation to be a second modulation type if the second decision statistic is less than the first decision statistic. The determination module 998 can also determine a selected modulation type by determining the selected modulation type to be a Gaussian minimum shift keying modulation type, an octal phase shift keying modulation type, or any other modulation type based on comparing the first decision statistic with the second decision statistic. The first decision statistic generator 992 can also generate a first decision statistic by generating the first decision statistic based on four bursts comprising a radio link control bock of the received signal. The first decision statistic can be generated according to ε₀=b^{T}(I−Z₀(Z₀^{T}Z₀)⁻¹Z₀)b and the second decision statistic can be generated according to ε₁=b^{T}(I−Z₁(Z₁^{T}Z₁)⁻¹Z₁)b.

The method of this invention, the controller 920, and the modulation detector 990 are preferably implemented on a programmed processor. However, the method, the controller 920, and the modulation detector 990 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention. For example, the method can be performed at a base station, at a network controller, at a mobile communication device, or anywhere else useful for detecting the modulation of a received signal.

While this invention has been described with specific embodiments thereof, it is evident that many alternatives, modifications, and variations will be apparent to those skilled in the art. For example, various components of the embodiments may be interchanged, added, or substituted in the other embodiments. Accordingly, the preferred embodiments of the invention as set forth herein are intended to be illustrative, not limiting. Various changes may be made without departing from the spirit and scope of the invention.

1. A method of modulation detection, comprising:
receiving a signal;
generating a first decision statistic based on the received signal;
phase rotating the received signal;
generating a second decision statistic based on the phase rotated received signal; and
determining a selected modulation type based on comparing the first decision statistic with the second decision statistic.

2. The method according to claim 1, further comprising generating an observation matrix from the received signal, wherein the first decision statistic is generated based on the observation matrix.

3. The method according to claim 1, further comprising generating an observation matrix from the phase-rotated received signal, wherein the second decision statistic is generated based on the observation matrix.

4. The method according to claim 1, wherein the step of determining a selected modulation type further comprises:
comparing the first decision statistic with the second decision statistic;
determining a desired modulation to be a first modulation type if the first decision statistic is less than or equal to the second decision statistic; and
determining a desired modulation to be a second modulation type if the second decision statistic is less than the first decision statistic.

5. The method according to claim 1, wherein the step of determining a selected modulation type determines the selected modulation type to be at least one of a Gaussian minimum shift keying modulation type and an octal phase shift keying modulation type based on comparing the first decision statistic with the second decision statistic.

6. The method according to claim 1, wherein generating a first decision statistic further comprises generating the first decision statistic based on four bursts comprising a radio link control bock of the received signal.

7. The method according to claim 1, wherein the first decision statistic is generated according to ε₀=b^{T}(I−Z₀ (Z₀^{T}Z₀)⁻¹Z₀)b.

8. The method according to claim 1, wherein the second decision statistic is generated according to ε₀=b^{T}(I−Z₁(Z₁^{T}Z₁)⁻¹Z₁)b .

9. A method of modulation detection, comprising:
receiving a signal;
constructing a first decision statistic based on a first hypothesized modulation type including interference suppression based on the received signal;
constructing a second decision statistic based on a second hypothesized modulation type including interference suppression based on the received signal; and
identifying a selected modulation type based on a comparison of the first decision statistic and the second decision statistic.

10. The method according to claim 9, wherein the first hypothesized modulation type is a Gaussian minimum shift keying modulation type.

11. The method according to claim 9, wherein the second hypothesized modulation type is an octal phase shift keying modulation type.

12. The method according to claim 9, further comprising:
transforming the received signal,
wherein the second decision statistic is based on the transformed received signal.

13. The method according to claim 12, wherein transforming the received signal further comprises phase rotating the received signal.

14. The method according to claim 9, wherein the first decision statistic is generated according to ε₀=b^{T}(I−Z₀(Z₀^{T}Z₀)⁻¹Z₀)b.

15. The method according to claim 9, wherein the second decision statistic is generated according to ε₁=b^{T}(I−Z₁(Z₁^{T}Z₁)⁻¹Z₁)b.

16. The method according to claim 9, wherein the step of identifying a selected modulation type further comprises:
comparing the first decision statistic with the second decision statistic;
determining a desired modulation to be a first modulation type if the first decision statistic is less than or equal to the second decision statistic; and
determining a desired modulation to be a second modulation type if the first decision statistic is less than the second decision statistic.

17. The method according to claim 16, wherein the first modulation type is a Gaussian minimum shift keying modulation type.

18. The method according to claim 16, wherein the first modulation type is an octal phase shift keying modulation type.

19. The method according to claim 9, wherein constructing a first and second decision statistic further comprises constructing the respective first and second decision statistics based on four bursts comprising a radio link control block of the received signal.

20. A method of modulation detection, comprising:
receiving a signal;
generating a first observation matrix from the received signal;
computing first decision statistic from first observation matrix;
phase-rotating the received signal;
generating a second observation matrix from the phase-rotated received signal;
computing a second decision statistic from the second observation matrix;
comparing the first decision statistic with the second decision statistic;
determining a desired modulation to be a Gaussian minimum shift keying modulation if the first statistic is less than or equal to the second statistic; and
determining a desired modulation to be an octal phase shift keying modulation if the second statistic is less than the first statistic.

21. A communication device comprising:
a receiver configured to receive a signal; and
a modulation detector configured to detect a modulation type of the received signal, the modulation detector including:
a first decision statistic generator configured to generate a first decision statistic based on the received signal;
a phase rotator configured to phase rotate the received signal;
a second decision statistic generator configured to generate a second decision statistic based on the phase rotated received signal; and
a determination module configured to determine a selected modulation type based on comparing the first decision statistic with the second decision statistic.

22. The communication device according to claim 21, wherein the first decision statistic generator is further configured to generate an observation matrix from the received signal, wherein the first decision statistic is generated based on the observation matrix.

23. The communication device according to claim 21, wherein the second decision statistic generator is further configured to generate an observation matrix from the phase-rotated received signal, wherein the second decision statistic is generated based on the observation matrix.

24. The communication device according to claim 21, wherein the determination module is further configured to determine a selected modulation type by comparing the first decision statistic with the second decision statistic, determining a desired modulation to be a first modulation type if the first decision statistic is less than or equal to the second decision statistic, and determining a desired modulation to be a second modulation type if the second decision statistic is less than the first decision statistic.

25. The communication device according to claim 21, wherein the determination module is further configured to determine a selected modulation type by determining the selected modulation type to be at least one of a Gaussian minimum shift keying modulation type and an octal phase shift keying modulation type based on comparing the first decision statistic with the second decision statistic.

26. The communication device according to claim 21, wherein the first decision statistic generator is further configured to generate a first decision statistic by generating the first decision statistic based on four bursts comprising a radio link control bock of the received signal.

27. The communication device according to claim 21, wherein the first decision statistic is generated according to ε₀=b^{T}(I−Z₀(Z₀^{T}Z₀)⁻¹Z₀)b.

28. The communication device according to claim 21, wherein the second decision statistic is generated according to ε₁=b^{T}(I−Z₁(Z₁^{T}Z₁)⁻¹Z₁)b.
